(19) United States
(12) Patent Application Publication
(10) Pub. No.: US 2008/0260146 A1
(43) Pub. Date: Oct. 23, 2008

(54) Electronic Circuit Arrangement and Method of Operating Such Electronic Circuit

(75) Inventor: Juergen Schroeder, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/916,333

(22) PCT Filed: May 16, 2006
(86) PCT No.: PCT/IB2006/051534

§ 371 Date: Dec. 3, 2007

(30) Foreign Application Priority Data
May 31, 2005 (EP) 05104664.7

(51) Int. Cl. H04L 9/06

(52) U.S. Cl. 380/46

(57) ABSTRACT

In order to provide an electronic circuit arrangement (100) comprising at least one random number generating unit (10) for generating at least one random number (RN; RN1), wherein a calculation or estimation of the random numbers (RN; RN1) used in software (20) is not possible, especially not by physical measuring methods, at least one additional or second random number generating unit (12) for generating at least one additional or second random number (RN2) is proposed.

The present invention relates in general to the technical field of authentication of electronic chip cards and terminals.

Specifically, the present invention relates to an electronic circuit arrangement as detailed in the preamble of claim 1 as well as to a method of operating such electronic circuit arrangement as detailed in the preamble of claim 6.

For reasons of security, random numbers for the generation of keys, in particular of secret keys, and for the authentication of electronic chip cards and terminals have to be actual random numbers but must not be pseudo-random numbers, as for example the random numbers being generated by an algorithm implemented in software.

For this reason, modern chip cards, in particular modern smart cards, comprise a hardware-based random number generator providing these random numbers. Such hardware-based random number generator has to be implemented in such way that the quality of the random numbers generated by the random number generator cannot be influenced by external physical properties, like the temperature or the supply voltage. In any case, an accidental or intended manipulation of one or several of the physical parameters must not result in a predictability of the random numbers generated.

Since it is very difficult to implement the above-mentioned requirements in silicon (for example with PN transitions as source of noise), the use of internal logical states and of feedback shift registers enables a switching with a clock frequency generated by different parameters.

If the C[entral]P[rocessing]U[nit] now reads out this shift register or results derived from it, the C[entral]P[rocessing]U[nit] receives a relatively good random number being not deterministically determinable from outside. A precondition for a high quality of the random numbers generated in such way is that the time intervals the random numbers are read out with are large in relation to the clock frequency assigned to the shift register.

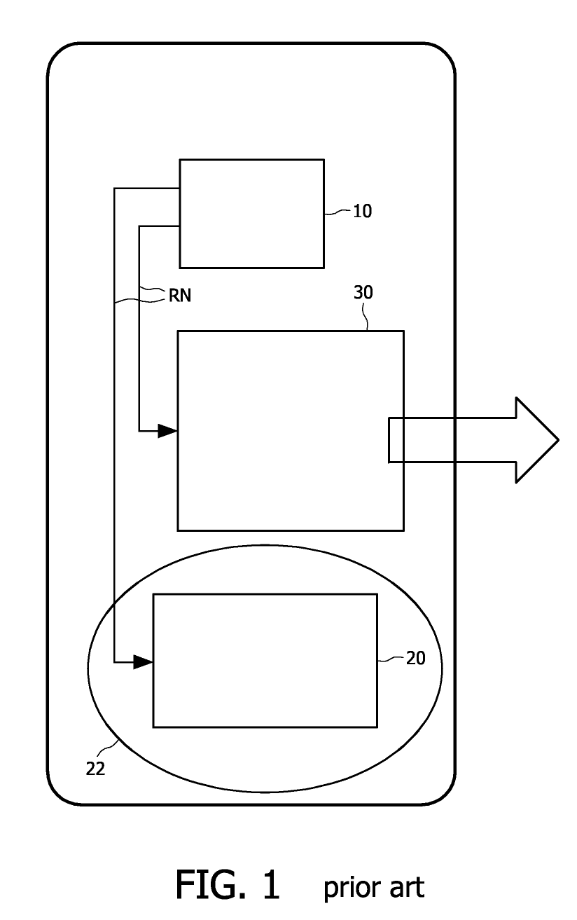

As shown in FIG. 1, prior art smart cards comprise one single random number generator 10 being implemented on hardware basis. The random number generator 10 is designed such that the random numbers RN generated cannot be directly calculated or estimated by means of physical measuring methods.

For security functions, such as for randomizing the cycles of the C[entral]P[rocessing]U[nit] (adding of additional wait states), for randomized branching in the execution of programs and for other random operations on the smart card, in general numerical values being derived from the random numbers generated by the hardware-based random number generator are used.

These operations have to be carried out very fast and very often; for these reasons, these operations do not fulfil the temporal requirements, namely that the time intervals the random numbers are read out with are large in relation to the clock frequency assigned to the shift register.

However, the randomizing, the randomized branching, random jumps or random transitions in the execution of the programs can be made visible by means of physical measuring methods; from these visible measuring results, the presently used random number can be deducted again by means of mathematical methods.

If random numbers are to be used for the on-chip generation of keys, in particular of secret keys, as well as for the authentication of electronic chip cards and terminals, during this time interval it has to be done without all (security) operations by which the internal states of the random number generator can be made visible by means of physical measuring methods.

With respect to the prior art as discussed above, it is generally known that the operation of the C[entral]P[rocessing]U[nit] can be disguised by a randomly added current propagation.

For instance, prior art document U.S. Pat. No. 6,419,159 B1 reveals to use a random number generator for disguising the operation of the C[entral]P[rocessing]U[nit] by a randomly added current propagation. The states of the random number generator are deliberately visible from outside though the execution of the code is to be kept secret requiring an implementation where the execution of the instructions is masked. However, prior art document U.S. Pat. No. 6,419,159 B1 does not take into consideration that random numbers can also be required by software.

In another example, prior art document U.S. Pat. No. 6,698,662 B1 reveals to use a random number generator for disguising the operation of the C[entral]P[rocessing]U[nit] or the programming of electrically erasable and programmable read-only-memories (EEPROMs) by a randomly added current propagation. The states of the random number generator are deliberately visible from outside though the current consumption is randomized. However, prior art document U.S. Pat. No. 6,698,662 B1 does not take into consideration that random numbers can also be required by software.

In prior art document EP 1 244 077 A2, the data being processed by the C[entral]P[rocessing]U[nit] is transformed and re-transformed in order to make this data secure; this results in a random current propagation during processing the data. Thus, the teaching of prior art document EP 1 244 077 A2 is based on disturbing (randomizing) the data before and after processing using constant hamming weight randomizers but a hardware-based random number generator is not used.

In prior art document EP 1 006 492 A1, a random number generator is used in order to disguise the operation of the C[entral]P[rocessing]U[nit] by a randomly added current propagation (in this case created by multiple execution of instructions), i.e. by randomizing the process sequence.

Prior art document US 2003/0194086 A1 refers to a random execution of instructions thus masking the cryptographic operation; to this end, a random number generator is used but the states of this random number generator are visible from outside.

Starting from the disadvantages and shortcomings as described above and taking the prior art as discussed into account, an object of the present invention is to further develop an electronic circuit arrangement of the kind as described in the technical field as well as a method of the kind as described in the technical field in such way that a calculation or estimation of random numbers used in software is not possible, especially not by physical measuring methods.

The object of the present invention is achieved by an electronic circuit arrangement comprising the features of claim 1 as well as by a method comprising the features of claim 6. Advantageous embodiments and expedient improvements of the present invention are disclosed in the respective dependent claims.

The present invention is based on the idea of improving the security of at least one chip of a data carrier, in particular of a chip card, for example of a smart card, by at least one additional or second random number generating unit producing random numbers having no correlation with the numbers generated by the first random number generating unit.

According to a preferred embodiment of the present invention, the first random number generating unit is used in software key generation and is protected, whereas the additional or second random number generating unit is used for randomizing the CPU cycles, wait states, execution delays etc and is visible from outside thereby masking software operations used for key generation.

Thus, the additional or second secure hardware-based random number generator can be implemented such on the data carrier, in particular on the chip card, for example on the smart card, that the data carrier operates completely independent of the first random number generator, i.e. there may be no correlation between the random numbers generated by the first random number generator and the numbers generated by the additional or second random number generator.

The present invention is further based on the assumption or idea that random numbers for the generation of keys, in particular for the generation of secret keys, have to be protected in a better way than random numbers being used for realizing security functions.

According to an advantageous embodiment of the present invention, the first random number generator generates secure random numbers for the on-chip generation of keys, in particular of secret keys; these secure random numbers are preferably only for use by the software.

According to an advantageous embodiment of the present invention, the additional or second random numbers generator generates random numbers for use by the hardware, as for instance for randomizing the cycles of the C[entral]P[rocessing]U[nit] (adding of additional wait states) or for randomized branching within the execution of the program. These random numbers are visible from outside due to the principle of the method of the present invention.

With the implementation as described above, the hardware functions using the additional or second random number generator can be used simultaneously with the generation of the random numbers for the on-chip key generation.

This is a significant advantage over the prior art where during the time interval of use of random numbers for the on-chip generation of keys, in particular of secret keys, as well as for the authentication of electronic chip cards and terminals, it had to be done without all (security) operations by which the internal states of the random number generator could be made visible by means of physical measuring methods.

In contrast to prior art document U.S. Pat. No. 6,419,159 B1, to prior art document EP 1 006 492 A1, and to prior art document US 2003/0194086 A1, the present invention discloses the principle of securing the states of the additional or second random number generator and thus the random numbers generated thereby for a subsequent use by the software itself; these random numbers do not become visible (for instance by way of the current propagation) from outside and thus remain secret.

Since the hardware operations using the second random number generator serve as security functions for disguising the internal processes on the data carrier, in particular on the chip card, for example on the smart card, the security of the data carrier is improved by the existence of the additional or second random number generator.

With the additional or second random number generator being available on the data carrier, it is no more possible to estimate or to calculate the random numbers used for the key generation by the software on the basis of internal states by means of physical measuring methods.

The first random number generator and the additional or second random number generator work independently of each other and are used for different tasks. Thereby, a separation of
random numbers which are generated by the first random number generator and which cannot be made visible from outside thus being usable by the software for the secure generation of keys, in particular of secret keys, and
random numbers which are generated by the additional or second random number generator and which can be made visible from outside is achieved.

The present invention further relates to a data carrier, in particular to a chip card, for example to a smart card, comprising at least one electronic circuit arrangement as described above.

The present invention, in particular the electronic circuit arrangement as described above and/or the method as described above, can be applied to the on-chip generation of keys, in particular of secret keys, as well as to the authentication of electronic chip cards and terminals; for such processes, random numbers are often required.

Random numbers are also used
for security functions, such as for randomizing of C[entral]P[rocessing]U[nit] cycles (adding of additional wait states),
for randomized branching in the execution of programs and
as “memory scramble values”.

As already discussed above, there are several options to embody as well as to improve the teaching of the present invention in an advantageous manner. To this aim, reference is made to the claims respectively dependent on claim 1 and on claim 6; further improvements, features and advantages of the present invention are explained below in more detail with reference to a preferred embodiment by way of example and to the accompanying drawings where

FIG. 1 schematically shows an electronic circuit arrangement according to the prior art; and

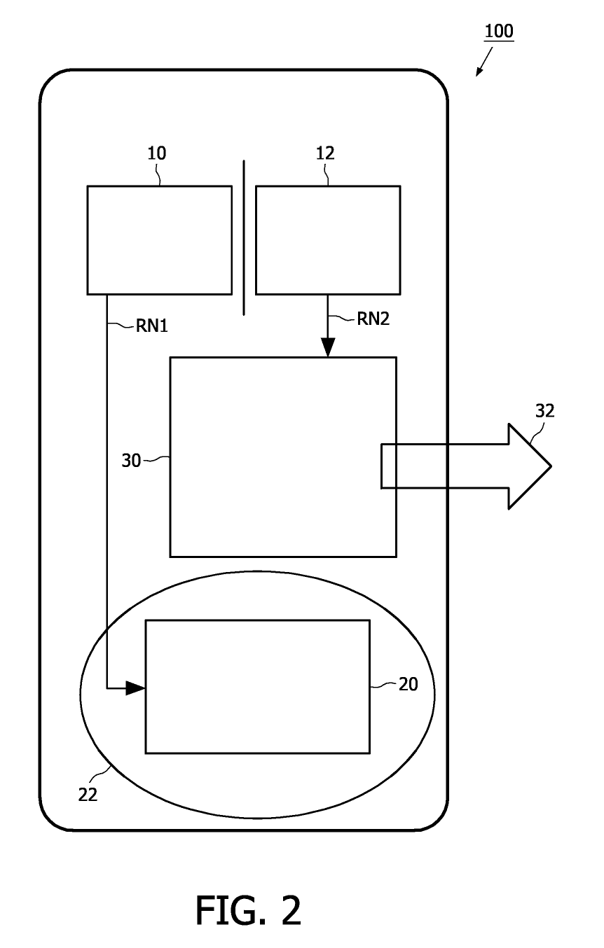

FIG. 2 schematically shows an embodiment of an electronic circuit arrangement according to the present invention working according to the method of the present invention.

The same reference numerals are used for corresponding parts in FIGS. 1 and 2.

As shown in FIG. 2, an embodiment being implemented by means of the present invention as an electronic circuit arrangement 100 comprises, amongst other things, a first random number generating unit 10 for generating a first random number RN1, and an additional or second random number generating unit 12 for generating an additional or second random number RN2. The electronic circuit arrangement 100 is part of a smart card chip being implemented on a smart card with improved security functions.

The additional or second secure random number generator 12 is completely independent of the first random number generator 10 in that way that no correlation appears between the random numbers RN1 generated by the first random number generator 10 and the random numbers RN2 generated by the additional or second random number generator 12.

While the first random number generator 10 generates secure first random numbers RN1 for use in key generation and only for use inside the smart card in context with the software 20, the second random number generator 12 generates second random numbers RN2 for use in the hardware 30 of the smart card, for example for randomizing the C[entral]P[rocessing]U[nit] cycles, for adding additional wait states or for randomized branching in executing the programs.

The second random numbers RN2 are visible from outside the smart card, i.e. there is an information leakage 32 but neither any calculation nor any estimation of the random numbers RN1 used in the software 20 is possible.

According to the present invention, functions of the hardware 30 using the second random number generator 12 and the generation of random numbers RN1 for on-chip key generation now are allowed to be operated simultaneously, which has not been possible so far without running the risk of the keys generated in the smart card to be discovered from outside by calculation or by estimation on the basis of information about the random numbers obtained from the investigation of internal physical states of the processor of the smart card.

### LIST OF REFERENCE NUMERALS

100 electronic circuit arrangement
10 random number generating unit, in particular first random number generating unit
12 additional or second random number generating unit
20 software
22 protection of software 20
30 hardware
32 information leakage but neither calculation nor estimation of first random number RN1 used in software 20
RN random number (=prior art; cf. FIG. 1)
RN1 random number, in particular first random number
RN2 additional or second random number

1. An electronic circuit arrangement comprising at least one random number generating unit for generating at least one random number, characterized by at least one additional or second random number generating unit for generating at least one additional or second random number.

2. The electronic circuit arrangement according to claim 1, characterized in that the additional or second random number generated by the additional or second random number generating unit does not comprise any correlation with the random number generated by the first random number generating unit.

3. The electronic circuit arrangement according to claim 2, characterized in
that the random number generated by the first random number generating unit
is used in operations of software, in particular for the generation of keys, for example of secret keys, and
is protected, and/or
that the additional or second random number generated by the additional or second random number generating unit
is used in operations of hardware, in particular for randomizing the cycles of the central processing unit, for adding additional wait states, for randomized branching and/or delaying within the execution of the program and for the like, and
is visible from outside thereby masking the operations of the software used for the generation of the keys.

4. The electronic circuit arrangement according to claim 1, characterized in that the operations of the hardware using the additional or second random number generating unit serve as at least one security function for disguising the internal processes on at least one data carrier, in particular on at least one chip card, for example on at least one smart card, the security of the data carrier being improved by the additional or second random number generating unit.

5. A data carrier, in particular a chip card, for example a smart card, characterized by at least one electronic circuit arrangement according to claim 1.

6. A method for operating an electronic circuit arrangement by which at least one random number is generated, characterized by generating at least one additional or second random number.

7. The method according to claim 6, characterized in that the additional or second random number does not comprise any correlation with the first random number.

8. The method according to claim 6, characterized in
that the first random number
is used in operations of software, in particular for the generation of keys, for example of secret keys, and
is protected, and/or
that the additional or second random number
is used in operations of hardware, in particular for randomizing the cycles of the central processing unit, for adding additional wait states, for randomized branching and/or delaying within the execution of the program and for the like, and
is visible from outside thereby masking the operations of the software used for the generation of the keys.

9. The method according to claim 6, characterized in that the operations of the hardware serve as at least one security function for disguising the internal processes on at least one data carrier, in particular on at least one chip card, for example on at least one smart card, the security of the data carrier being improved by the additional or second random number.

10. Use of at least one electronic circuit arrangement (100) according to claim
for the on-chip generation of at least one key, in particular of at least one secret key,
for the authentication of at least one electronic data carrier, in particular of at least one chip card, for example of at least one smart card, and of at least one terminal,
for security functions, such as for randomizing of at least one cycle of at least one central processing unit,
for adding additional wait states,
for randomized branching in the execution of at least one program, and/or
as at least one memory scramble value.
